(19) United States
(12) Patent Application Publication
(10) Pub. No.: US 2008/0113532 A1
(43) Pub. Date: May 15, 2008

(54) Pick-and-place card guide clip-on grounding members

(76) Inventor: David Christopher Smeltz, Easton, PA (US)

Correspondence Address: HARNESS, DICKEY, & PIERCE, P.L.C, 7700 BONHOMME, STE 400, ST. LOUIS, MO, 63105, US

(21) Appl. No.: 11/640,508

(22) Filed: Dec. 15, 2006

Related U.S. Application Data
(60) Provisional application No. 60/858,632, filed on Nov. 13, 2006.

(51) Int. Cl. H01R 4/66

(52) U.S. Cl. 439/92

(57) ABSTRACT

According to various aspects, exemplary embodiments are provided of grounding members capable of being retrieved from pockets of a carrier tape by pick-and-place equipment, and to then be placed by the pick-and-place equipment onto substrates for establishing electrical grounding contact from electrically-conductive portions on the substrates to card guides. In one exemplary embodiment, a grounding member includes a channel, a resiliently flexible contact finger, and a generally flat portion. The channel is configured to engagingly receive an edge portion of a substrate therein for helping mechanically retain the grounding member to the substrate and establish electrical contact with at least one electrically-conductive portion of the substrate. The resiliently flexible contact finger element is disposed generally opposite the channel. The resiliently flexible contact finger element is configured so as to allow the substrate with the grounding member clipped thereon to be slidably received within a groove of a card guide, and to establish electrical contact with at least a portion of the card guide. The generally flat portion is adjacent the resiliently flexible contact finger element, and is configured to enable the grounding member to be picked up by a head associated with pick-and-place equipment.

### CROSS-REFERENCE TO RELATED APPLICATION

This application claims the benefit of U.S. Provisional Application No. 60/858,632 filed Nov. 13, 2006, the disclosure of which is incorporated herein by reference.

### FIELD

The present disclosure generally relates to clip-on grounding members capable of being retrieved from pockets of a carrier tape by pick-and-place equipment, and to then be automatically placed by the pick-and-place equipment onto edge portions of substrates for establishing electrical grounding contact from electrically-conductive portions on the substrates to card guides.

### BACKGROUND

The statements in this section merely provide background information related to the present disclosure and may not constitute prior art.

Electronic cards are commonly used, for example, when adding capacity and/or functionality to personal computers. Standards for such cards have been established (type I, type II, and type III cards) by the Personal Computer Memory Card International Association (PCMCIA). A PCMCIA card is a credit card-size memory or I/O device that connects to a personal computer, usually a notebook or laptop computer. Structurally, electronic cards usually include one or more printed circuit boards interposed between shields that provide rigidity sufficient to exceed applicable bending and torsional resistance specification.

Electronic cards and other substrates, such as printed circuit boards, are commonly mounted within personal computers, chasses, and rack systems by way of card guides. By way of example, the card guides allow for relatively easy installation by sliding the substrate's edges along the channels, grooves, slots, etc. defined by the card guides. During this sliding installation procedure, the card guides help guide the electronic cards or printed circuit board (as the case may be) into their operational, installed positions. The card guides may also help hold the electronic cards or printed circuit boards relatively securely in place and inhibit flexing and bending thereof. Card guides usually allow for relatively easy removal of installed electronic cards or printed circuit boards, for example, when repairs and/or replacements are needed.

Electronic cards and circuit boards usually include electrical components that radiate electromagnetic waves, which may cause noise or unwanted signals to appear in electrical devices existing within a certain proximity of the radiating electrical components. Accordingly, it is not uncommon to provide grounding for circuitry that emits or is susceptible to electromagnetic radiation, to thereby allow offending electrical charges and fields to be dissipated without disrupting operation.

### SUMMARY

According to various aspects, exemplary embodiments are provided of grounding members capable of being retrieved from pockets of a carrier tape by pick-and-place equipment, and to then be placed by the pick-and-place equipment onto substrates for establishing electrical grounding contact from electrically-conductive portions on the substrates to card guides. In one exemplary embodiment, a grounding member includes a channel, a resiliently flexible contact finger, and a generally flat portion. The channel is configured to engagingly receive an edge portion of a substrate therein for helping mechanically retain the grounding member to the substrate and establish electrical contact with at least one electrically-conductive portion of the substrate. The resiliently flexible contact finger element is disposed generally opposite the channel. The resiliently flexible contact finger element is configured so as to allow the substrate with the grounding member clipped thereon to be slidably received within a groove of a card guide, and to establish electrical contact with at least a portion of the card guide. The generally flat portion is adjacent the resiliently flexible contact finger element. The generally flat portion is configured to enable the grounding member to be picked up by a head associated with pick-and-place equipment.

Other aspects provide methods relating to installation of a grounding member onto an edge portion of a substrate having at least one electrically-conductive portion thereon. The grounding member may have a channel, a resiliently flexible contact finger element, and a generally flat portion adjacent the resiliently flexible contact finger element. In one exemplary embodiment, a method generally includes applying suction to the generally flat portion of the grounding member by using a head associated with pick-and-place equipment. While applying the suction, the head may then be moved to pick-up and place the grounding member onto the edge portion of the substrate such that the substrate's edge portion is received within the grounding member's channel, and such that at least a portion of the grounding member electrically contacts at least one electrically-conductive portion on the substrate. The method may also include slidably positioning the substrate (having the grounding member clipped thereto) along at least one card guide such that the resiliently flexible contact finger element of the grounding member electrically contacts at least a portion of the card guide. At which point, the grounding member may thus establish electrical grounding contact from the electrically-conductive portion on the substrate to the card guide. The method may also include supplying a carrier tape having at least one pocket in which is positioned the grounding member. The grounding member's generally flat portion may be adjacent the opening into the pocket so as to allow the head to apply suction to the generally flat portion for retrieving the grounding member from the pocket.

Further aspects and features of the present disclosure will become apparent from the detailed description provided hereinafter. In addition, any one or more aspects of the present disclosure may be implemented individually or in any combination with any one or more of the other aspects of the present disclosure. It should be understood that the detailed description and specific examples, while indicating exemplary embodiments of the present disclosure, are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a pick-and-place card guide clip-on grounding member according to exemplary embodiments;

FIG. 2 is another perspective view of the clip-on grounding member shown in FIG. 1;

FIG. 3 is a side elevation view of the clip-on grounding member shown in FIG. 1;

FIG. 4 is an end elevation view of the clip-on grounding member shown in FIG. 1;

FIG. 5 is a top plan view of the clip-on grounding member shown in FIG. 1;

FIG. 6 is a plan view of a blank prior to forming the blank into the clip-on grounding member shown in FIG. 1 according to exemplary embodiments;

FIG. 7 is a side elevation view of the clip-on grounding member shown in FIG. 1 with exemplary dimensions provided for purposes of illustration only according to exemplary embodiments;

FIG. 8 is an end elevation view of the clip-on grounding member shown in FIG. 1 with exemplary dimensions provided for purposes of illustration only according to exemplary embodiments;

FIG. 9 is a top plan view of the clip-on grounding member shown in FIG. 1 with exemplary dimensions provided for purposes of illustration only according to exemplary embodiments;

FIG. 10 is a plan view of a blank prior to forming the blank into the clip-on grounding member shown in FIG. 1 with exemplary dimensions provided for purposes of illustration only according to exemplary embodiments;

FIG. 11 is a perspective view of a pick-and-place card guide clip-on grounding member having D-shaped lance features according to another exemplary embodiment;

FIG. 12 is another perspective view of the clip-on grounding member shown in FIG. 11;

FIG. 13 is a side elevation view of the clip-on grounding member shown in FIG. 11; and

FIG. 14 is a perspective view illustrating an exemplary manner in which clip-on grounding members as shown in FIGS. 1 through 5 may be stored in pockets of a continuous tape reel for retrieval by a head (not illustrated) of a pick-and-place machine.

### DETAILED DESCRIPTION

The following description is merely exemplary in nature and is in no way intended to limit the present disclosure, application, or uses. It should be understood that throughout the drawings, corresponding reference numerals indicate like or corresponding parts and features.

According to various aspects, exemplary embodiments are provided of grounding members capable of being retrieved from pockets of a carrier tape by pick-and-place equipment, and to then be placed by the pick-and-place equipment onto substrates for establishing electrical grounding contact from electrically-conductive portions on the substrates to card guides. In one exemplary embodiment, a grounding member includes a channel, a resiliently flexible contact finger, and a generally flat portion. The channel is configured to engagingly receive an edge portion of a substrate therein for mechanically retaining the grounding member to the substrate, and electrically contacting at least one electrically-conductive portion of the substrate. The resiliently flexible contact finger element is disposed generally opposite the channel. The resiliently flexible contact finger element is configured (e.g., shaped, sized, located, formed of sufficiently flexible materials, etc.) so as to allow the substrate with the grounding member clipped thereon to be slidably received within a groove of a card guide, and to establish electrical contact with at least a portion of the card guide. The generally flat portion is adjacent the resiliently flexible contact finger element. The generally flat portion is configured (e.g., sized, shaped, located, etc.) as a pick-up area, to thereby enable the grounding member to be picked up by a head associated with pick-and-place equipment, such as a pneumatic head, vacuum pick-and-place head, suction cup pick-and-place head, etc.

Additional aspects relate to methods of making grounding members. Still other aspects provide methods relating to installation of a grounding member onto an edge portion of a substrate having at least one electrically-conductive portion thereon. In one exemplary embodiment, a method generally includes applying suction to a generally flat portion of a grounding member by using a head (e.g., pneumatic head, vacuum pick-and-place head, suction cup pick-and-place head, etc.) associated with pick-and-place equipment. While applying suction, the head may then be moved to pick-up and place the grounding member onto the edge portion of the substrate such that the substrate's edge portion is received within a channel of the grounding member, and such that at least a portion of the grounding member electrically contacts an electrically-conductive portion on the substrate. The method may also-include slidably positioning the substrate (having the grounding member clipped thereto) along at least one card guide such that a resiliently flexible contact finger element of the grounding member electrically contacts at least a portion of the card guide. At which point, the grounding member thus establishes electrical grounding contact from the electrically-conductive portion on the substrate to the card guide. The method may also include supplying a carrier tape having at least one pocket with an opening into the pocket and in which is positioned the grounding member. The grounding member's generally flat portion may be adjacent the opening (e.g., upwardly facing relative to the opening into the pocket) so as to allow the head to apply suction to the generally flat portion for retrieving the grounding member from the pocket.

Accordingly, various embodiments provide grounding members that may be relatively easily installed onto substrates with relatively low compression forces and/or by using pick-and-place equipment. Once installed, the grounding members may provide excellent electrical grounding contact from the substrate (e.g., ground trace on printed circuit board or electronic card, etc.) to a card guide of a rack. Some embodiments include the resiliently flexible contact finger element being configured for inhibiting snagging of the resiliently flexible contact finger element within the groove as the substrate with the grounding member clipped thereon is sliding along the groove of the card guide. To this end, some embodiments include the resiliently flexible contact finger element having a generally rounded or arcuate transverse profile and that is formed from a resiliently flexible material. With this particular configuration, the resiliently flexible contact finger element is able to flex or compress downwardly a force is applied thereto as the substrate is slided along the groove of the card guide.

In some embodiments, a grounding member includes one or more D-shaped lance features that are configured for helping the grounding member remain clipped onto a mounting surface when the D-shaped lance feature is engagingly received within an opening defined by the mounting surface.

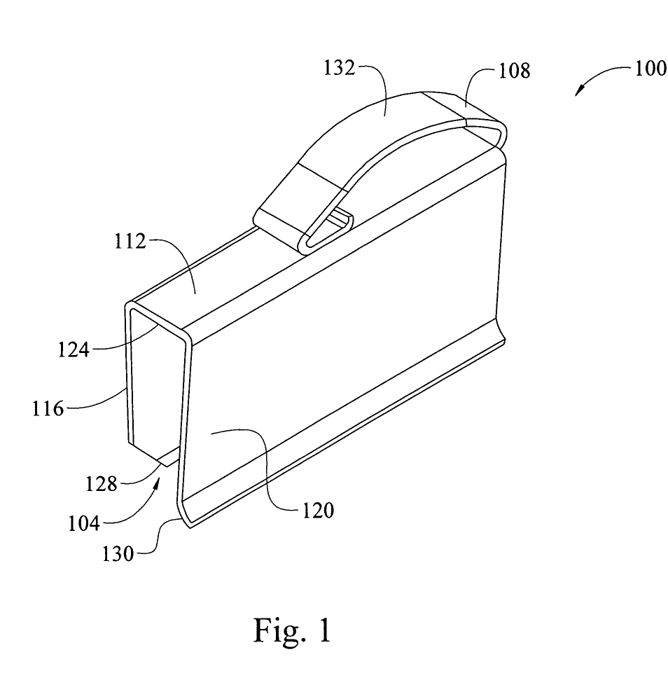

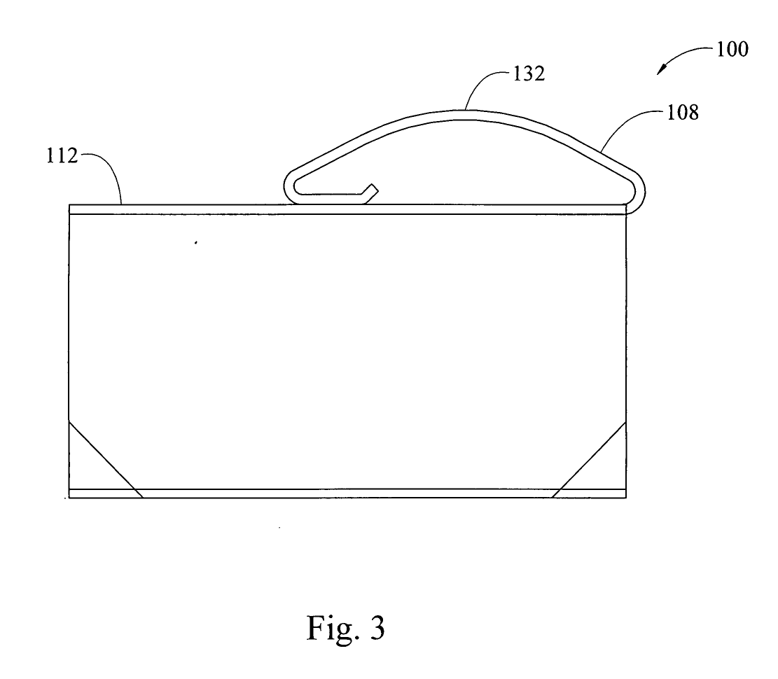

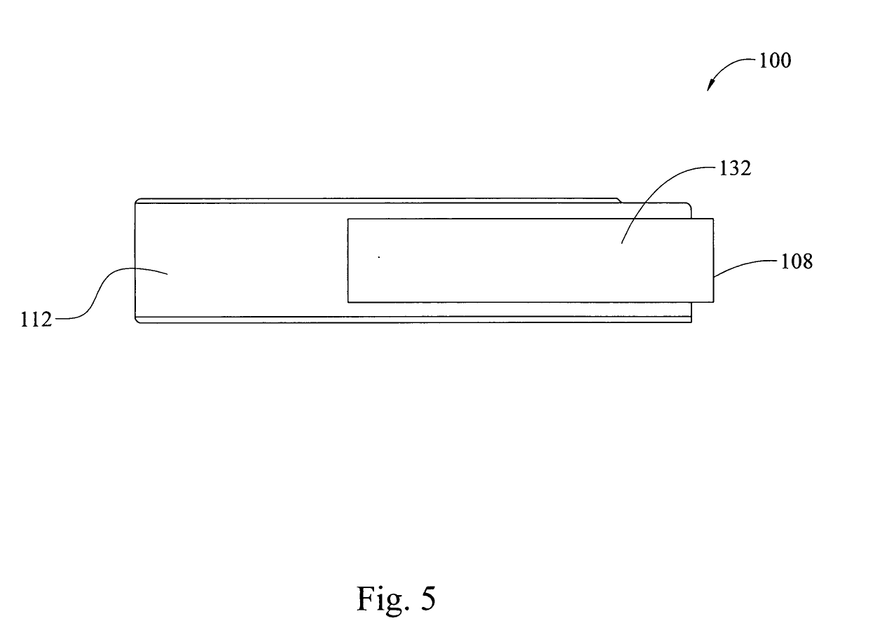

FIGS. 1 through 5 illustrate an exemplary grounding member 100 embodying one or more aspects of the present disclosure. As shown in FIGS. 1 through 5, the grounding member 100 includes a channel 104, a contact finger element 108, and a generally flat “pick-up” portion 112. The generally flat portion 112 is preferably configured (e.g., sized, shaped, located, etc.) as a pick-up area to allow the grounding member 100 to be handled by pick-and-place equipment, as described in more detail below.

In the illustrated embodiment, the channel 104 extends generally longitudinally along a length of the grounding member 100. Alternatively, other embodiments may include two or more channels separated by openings (e.g., slots, etc.) rather than having a single continuous channel. In either case, the channel(s) are preferably configured to engagingly receive an edge portion of a substrate (e.g., electronic card, printed circuit board, etc.) for helping to mechanically retain the grounding member 100 clipped onto a substrate.

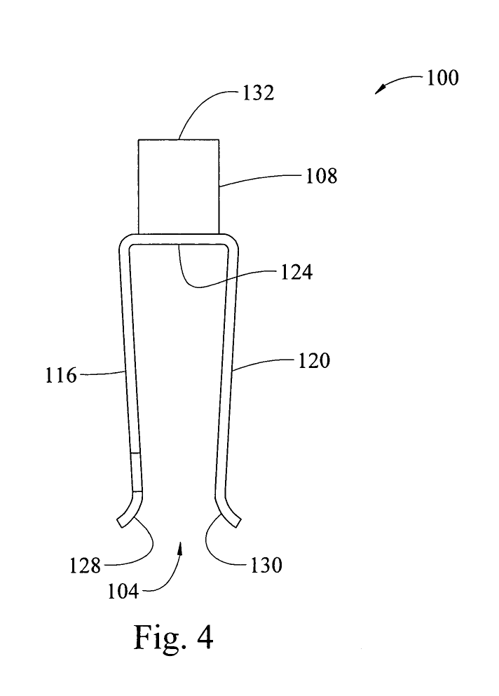

As shown in FIG. 4, the channel 104 includes first and second generally opposing side wall portions 116, 120 connected by a third wall portion 124. The first, second, and third wall portions or legs 116, 120, 124 cooperatively define a generally inverted U-shaped or C-shaped cross-section or transverse profile for the channel 104. Alternatively, other embodiments may have channels with different transverse profiles than what is shown in the figures depending, for example, at least in part on the particular substrate to which the grounding member 100 will be installed and desired clamping force and electrical contact to be produced by the grounding member 100.

The channel 104 may be configured for frictionally engaging the substrate when the edge portion thereof is received within the channel 104. The channel's wall portions 116, 120 may be configured for squeezing the opposite surfaces of the substrate after the substrate's edge portion has been engagingly received within the channel 104. The side wall portions 116, 120 may be resiliently biased inwardly (or configured otherwise) to create a flexible tension grip of the side wall portions 116, 120 onto the substrate sufficient for inhibiting removal of the grounding member 100 from the substrate during normal use, such as when the substrate is being slid along a card guide.

A gap may be provided between the side wall portions 116, 120 that is less than the thickness of the substrate onto which the grounding member 100 will be installed. When the substrate is positioned between the side wall portions 116, 120 into the gap, the side wall portions 116, 120 are caused to separate slightly. Due to the resilience of the material(s) from which the side wall portions 116, 120 are preferably made, the side wall portions 116, 120 may then spring back and press against the substrate. Accordingly, this allows the grounding member 100 to be readily easily and quickly installed (“clip or snap into place”) onto a substrate without requiring the use of mechanical fasteners. This feature can also allow for ready and easy removal of a grounding member 100 from the substrate. The channel 104 is preferably configured to allow the grounding member 100 to be clipped onto and installed to a substrate with relatively low force.

In the illustrated embodiment, the side wall portions 116, 120 are generally straight but angled at least slightly inward to frictionally receive and grip a substrate between the side wall portions 116, 120. Accordingly, the channel 104 has a cross-section or transverse profile that is generally an inverted U-shape or C-shape, but with corners forming acute angles. As noted above, other cross-sections and transverse profiles are possible for the channel 104 depending, for example, at least in part on the particular substrate to which the grounding member 100 will be installed and desired clamping force and electrical contact to be produced by the grounding member 100.

In other embodiments, the side wall portions 116, 120 may be straight without any inward or outward slant such that right angles are defined generally between the inner surfaces of each side wall portion 116, 120 and the inner surface of the upper wall portion 124. In still other embodiments, the side wall portions 116, 120 may be angled at least slightly outward such that obtuse angles are defined generally between the inner surface of each side wall portion 116, 120 and the inner surface of the upper wall portion 124. Further embodiments are configured such that the angles defined generally between the inner surface of each side wall portion 116, 120 and the inner surface of the upper wall portion 124 are not equal.

When the grounding member 100 has been clipped onto an edge portion of a substrate, the grounding member 100 preferably makes good electrical contact with at least one electrically-conductive portion (e.g., ground trace, etc.) on the substrate. For example, some embodiments may include either of both end portions 128, 130 of the respective side wall portions 116, 120 contacting a ground trace of a printed circuit board with sufficient contact pressure effective for establishing at least a certain or desirable level of electrical conductivity between the grounding member 100 and the ground trace. In such embodiments, the side wall portions 116, 120 may cooperatively generate a sufficient clamping force to mechanically retain the grounding member 100 to the substrate and to create sufficient contact pressure between at least a portion of the grounding member 100 and the ground trace to establish good electrical conductivity therebetween.

With continued reference to FIG. 4, the end portions 128, 130 of the respective side wall portions 116, 120 may be configured so as to be operable as camming surface portions. In such embodiments, the camming surface portions may contact the substrate during installation. This contact may cause the sidewall portions 116, 120 to move generally outward and away from each other, which may, in turn, facilitate positioning of the substrate's edge portion within the channel 104.

In various embodiments, the channel 104 is configured (e.g., sized, formed of resilient materials, etc.) to allow the grounding member 100 to be clipped onto substrates having thicknesses between about 0.085 inches and about 0.100 inches (about 2.159 millimeters and about 2.540 millimeters). Alternatively, other grounding members may have channels configured for clipping onto substrates having a thickness less than 0.085 inches. Still other grounding members may have channels configured for clipping onto substrates having a thickness greater than 0.100 inches. The dimensions provided in this paragraph (as are all dimensions disclosed herein) are for purposes of illustration only and not for purposes of limitation.

With continued reference to FIGS. 1 through 3, the grounding member 100 includes the contact finger element 108. The contact finger element 108 defines a contact portion 132. As disclosed herein, the contact portion 132 may electrically contact a portion of a card guide when a card or substrate (on which the grounding clip 100 is installed) is slidably positioned within the card guide. In such embodiments, the grounding member 100 may thus establish electrical grounding contact from a ground trace on the card to the card guide.

As shown in FIGS. 1 through 3, the contact finger element 108 is disposed generally over about half of the outer surface of the third wall portion 124. The contact finger element 108 bends, wraps, or curves so as to form a rounded or generally arcuate cross-section or transverse profile. Alternatively, other embodiments may have contact finger elements with different cross-sections or transverse profiles than what is shown in the figures depending, for example, on the particular installation intended for the grounding member.

In various embodiments, the grounding member 100 may be used for grounding purposes by electrically contacting another surface that would bear against the contact portion 132 defined by the finger element 108, for example, with a force having a component perpendicular to a longitudinal axis of the grounding member 100. In use, the contact portion 132 may be borne against by another surface (e.g., portion of the card guide, etc.) causing the finger element 108 to flex generally towards the channel 104. When the loading surface is removed from being in contact with grounding member 100, the resilient nature of the material out of which the grounding member 100 and/or contact finger element 108 are preferably constructed allows the contact finger element 108 to return to the unloaded position (shown in FIGS. 1 through 3). The material from which the grounding member 100 is constructed may be preferably selected so that during use of the grounding member 100, the yield point of the material is not reached and no plastic deformation of the material occurs.

With reference now to FIGS. 1, 2, 3, 5, and 14, the grounding member 100 includes a generally flat “pick-up” portion 112. As shown, the flat “pick-up” portion 112 is defined by an outer surface of the upper wall portion 124. Alternatively, the pick-up portion 112 may instead comprise a discrete component that is separately attached to the upper wall portion 124, for example, by welding, adhesives, among other suitable methods.

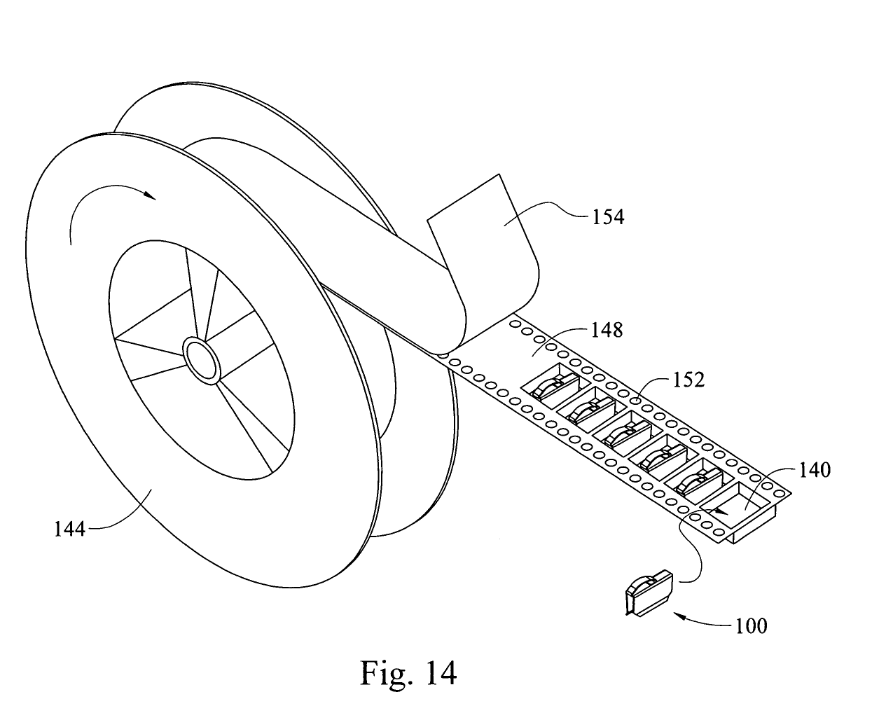

For purposes of illustration only, a description will be provided of an exemplary process by which grounding members 100 may be installed onto a substrate using pick-and-place equipment (e.g., pneumatic head, vacuum pick-and-place head, suction cup pick-and-place head, etc.). FIG. 14 illustrates an exemplary manner in which clip-on grounding members 100 (as shown in FIGS. 1 through 5) may be stored in pockets 140 of a continuous tape reel 144 for retrieval by a head (not illustrated) of a pick-and-place machine, such as a pneumatic head, vacuum pick-and-place head, suction cup pick-and-place head, etc.

As shown in FIG. 14, the grounding members 100 are positioned in the upwardly opening pockets 140 of the plastic carrier tape 148. A cover strip 154 may be adhesively applied to the top layer of the carrier tape 148 to hold the grounding members 100 in position within the pockets 140. The carrier tape 148 may be wound onto or wrapped around the reel 144 before shipment to a customer. Upon receipt, the customer may install the reel 144 (with the grounding members 100 positioned in the pockets 140 thereof of a feeder associated with an automatic pick-and-place machine.

With continued reference to FIG. 14, the carrier tape 148 may have holes 152 formed along one or both side edges thereof for driving through a feeder mechanism (not illustrated) installed in a pick-and-place machine. The tape 148, with the grounding member 100 stored within the pockets 140, and the cover layer 154 in place, may be unwound from the supply reel 144 in the feeder. The feeder peels back the top cover layer 154. The head (not illustrated) of the pick-and-place machine may apply suction to the “pick-up” portion 112 of a grounding member 100 to lift the same from its corresponding pocket 140 in the tape 148. Accordingly, the grounding member 100 is preferably provided with a sufficiently sized “pick-up” portion 112 to allow the head of a pick-and-place machine to apply suction to the “pick-up” portion 112 for removing the grounding member 100 from its corresponding pocket 140. After retrieving the grounding member 100 from the pocket 140, the head may then install or clip the grounding member 100 onto an edge portion of a substrate. By providing grounding members capable of being retrieved from pockets by pick-and-place machines associated with assembly line production, embodiments disclosed herein may allow for increased productivity for assembly line production of printed circuit boards, electronic cards, etc.

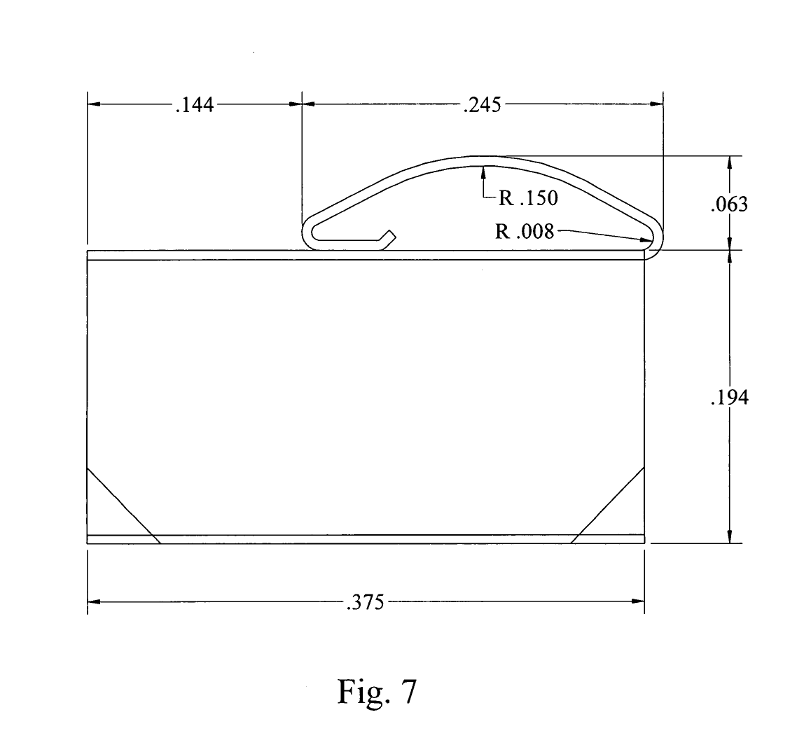

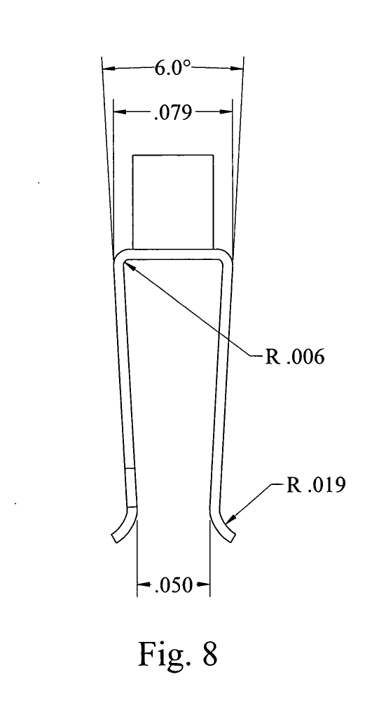

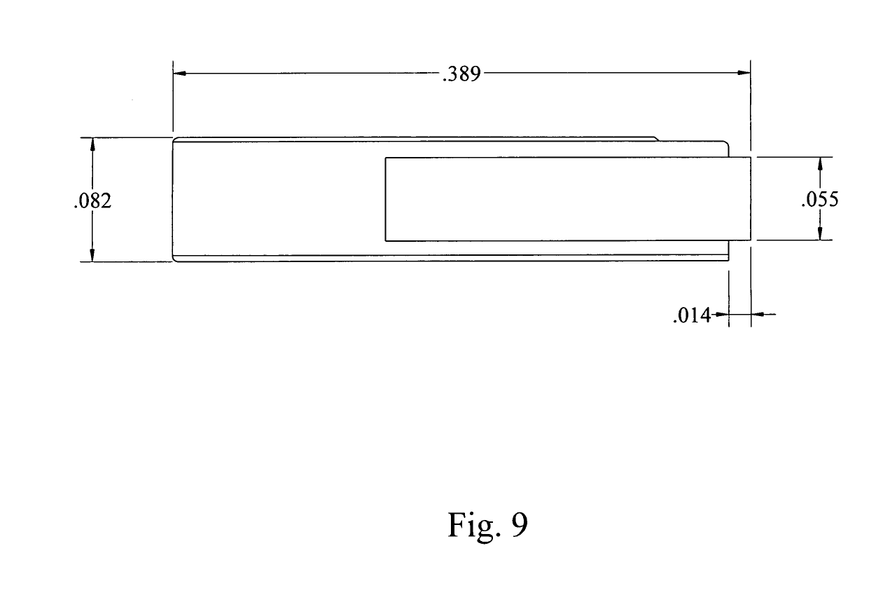

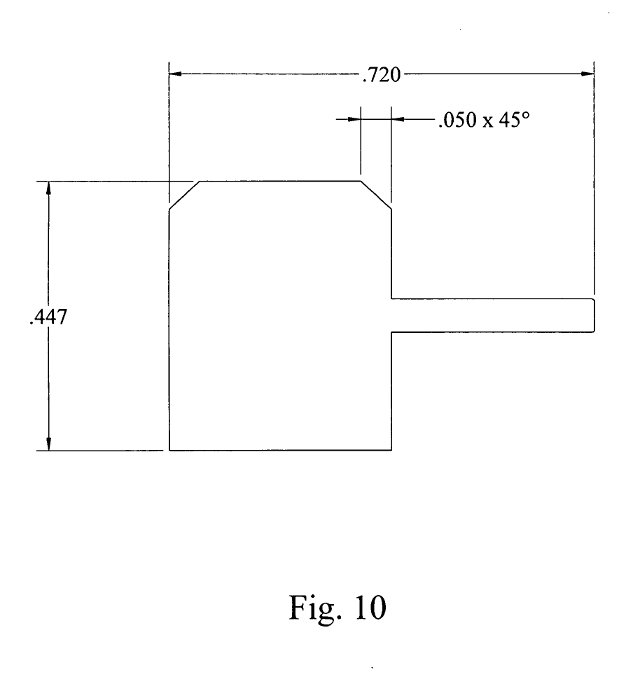

FIGS. 7 through 10 illustrate exemplary dimensions in inches that may be used for the grounding member 100 shown in FIGS. 1 through 5. These dimensions are provided solely for purposes of illustration and not for purposes of limitation. In the particular embodiment illustrated in FIGS. 7 through 10, the grounding member 100 may have the dimensions shown therein with a tolerance of ±0.010 inch for dimensions shown to two decimal places, a tolerance of ±0.005 inches for dimensions shown to three decimal places, and angular tolerances of ±3 degrees. These dimensions (as are all dimensions set forth herein) are for purposes of illustration only as the specific dimensions for a particular application may depend, for example, upon the length of the grounding member, desired grounding contact, material properties of the grounding member, and particular installation (e.g., thickness of the mounting surface, substrate edge, etc. on which the grounding member will be positioned, amount of curvature or bending needed for installing the grounding member, etc.). The dimensions of the grounding member may be varied in order to tailor the grounding member for a particular application.

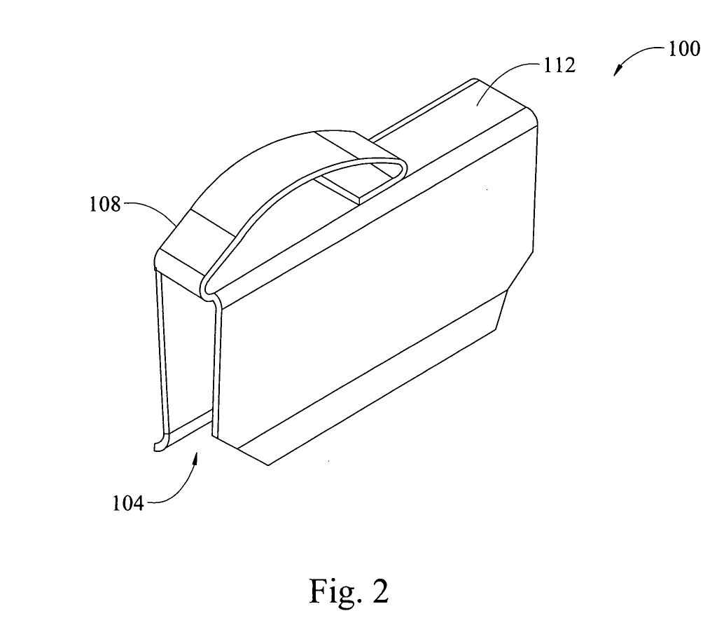

In various embodiments, the grounding member 100 may be integrally or monolithically formed as a unitary component. In such embodiments, the grounding member 100 may comprise a unitary metal clip stamped from a flat strip of sheet metal, which is then bent or formed into the configuration shown in FIGS. 1 and 2. In some embodiments, the grounding member 100 may be manufactured through a continuous process involving stamping and bending of sheet metal strips.

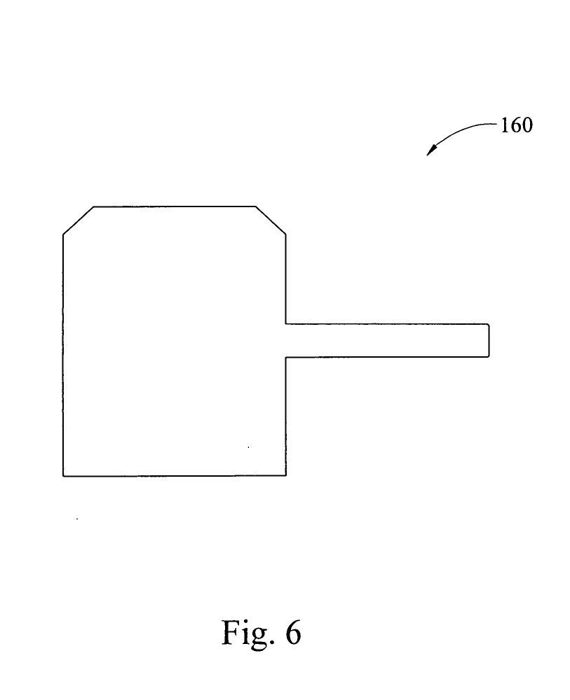

FIG. 6 illustrates a piece of material 160 having a flat pattern that can be used for making the grounding member 100. After stamping this flat pattern (FIG. 6) in the piece of material, the material may be folded, bent, or otherwise formed into the configuration shown in FIGS. 1 and 2. Even though the grounding member 100 may be formed integrally in this example, such is not required for all embodiments. For example, other embodiments may include the contact finger 108 as a discrete component that is separately attached to the upper wall portion 124, for example, by welding, adhesives, among other suitable methods. Alternative configurations (e.g., shapes, sizes, etc.), materials, and manufacturing methods (e.g., drawing, etc.) may be used for making the grounding member 100.

A wide range of materials, preferably resiliently flexible and electrically conductive, may be used for a grounding member (e.g., 100, 200, etc.) disclosed herein. In various embodiments, the grounding member is formed from resiliently flexible material that is elastic in nature with a modulus of elasticity sufficient so that the channel's wall portions and/or the contact finger element may be displaced by a force from an unloaded position to a loaded position, and then return to the unloaded position upon the removal of this force without exceeding the yield point of the material. Additionally, or alternatively, the grounding member in some embodiments is formed from an electrically-conductive material capable of conducting electricity therethrough with impedance sufficiently low enough for electromagnetic interference/radio frequency interference (EMI/RFI) shielding applications.

By way of further example, some embodiments include a grounding member formed from stainless steel or beryllium copper alloy (e.g., beryllium copper alloy 25¼ hard having a thickness of 0.006 inches thick with a tolerance of ±0.0002 inches, etc.). The beryllium copper alloy may include between about 1.8% (weight) and about 2.0% (weight) beryllium, a maximum of about 0.6% (weight) of the combination of cobalt, nickel, and iron, and the balance copper, which alloy has an electrical conductivity of between about 22% and about 28% IACS (International Annealed Copper Standard). An example of a suitable alloy is available from Brush Wellman, Cleveland, Ohio, as Brush Alloy 25 (copper alloy UNS number C17200). Other suitable materials may also be used, such as phosphor bronze, copper-clad steel, brass, monel, aluminum, steel, nickel silver, other beryllium copper alloys, among others. Furthermore, the material can optionally be pre-plated or post-plated for galvanic compatibility with the surface on which it is intended to be mounted. Alternatively, the material can be a molded or cast polymer that is loaded or coated to be electrically-conductive.

In one particular embodiment, the grounding member 100 is formed from beryllium copper alloy 25¼ hard having an initial thickness of 0.006 inches (with a tolerance of ±0.0002 inches), and which has undergone heat treating such that the diamond-pyramid hardness number (DPH) is about 353 or more using a 500 gram load. The beryllium copper alloy may be cleaned, and provided with a finish for galvanic compatibility (e.g., bright tin finish per MIL-T-10727 in a thickness of about 0.0002 inches with a tolerance of ±0.0001 inch, etc.).

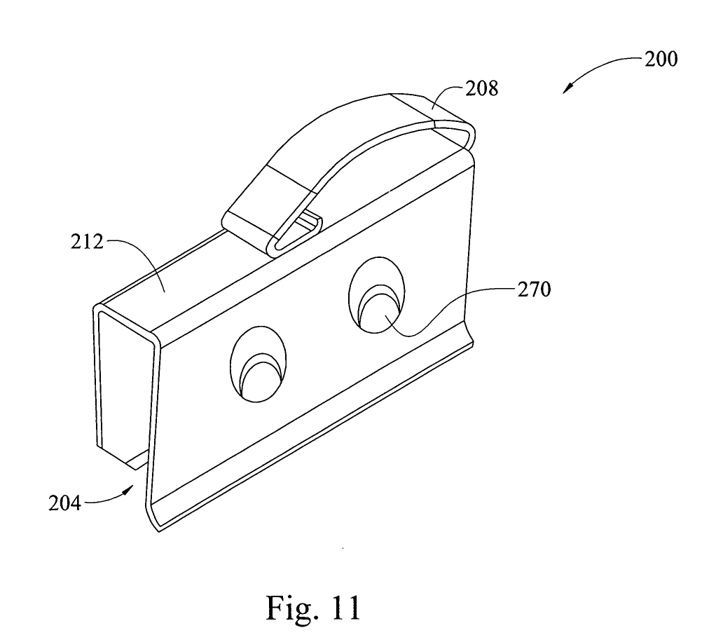

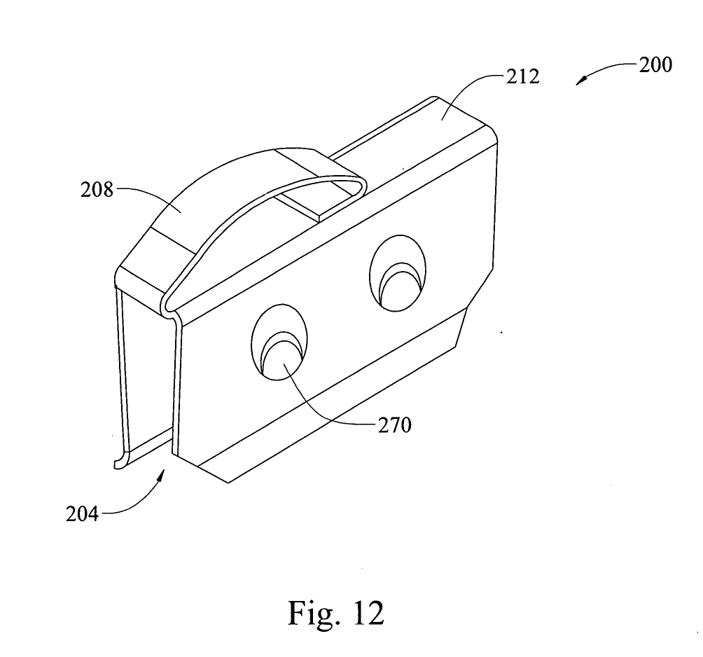

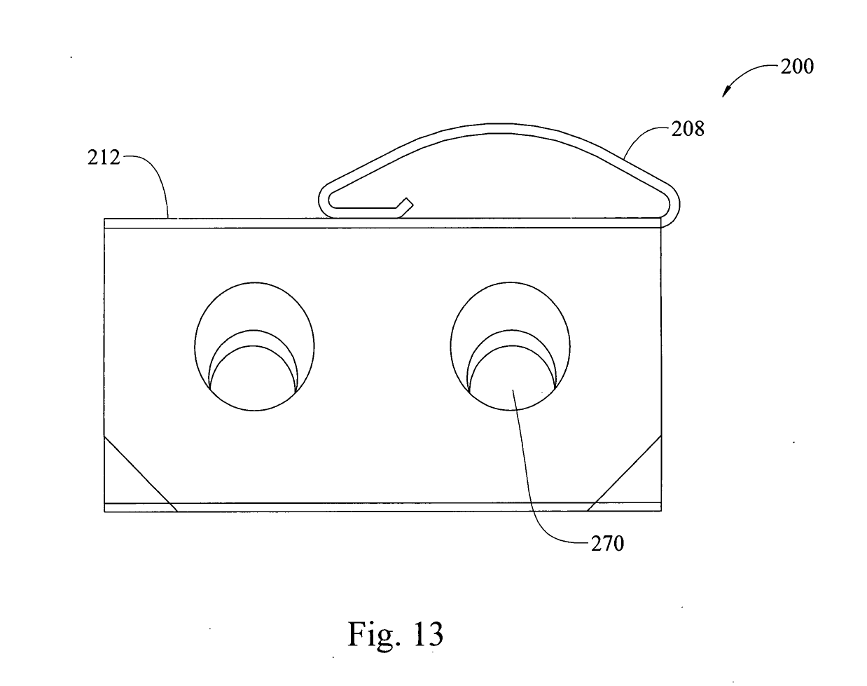

FIGS. 11 through 13 illustrate another exemplary embodiment of a grounding member 200 embodying one or more aspects of the disclosure. As shown, the grounding member 200 includes a channel 204, contact finger element 208, and a generally flat “pick-up” portion 212. In addition, this particular embodiment of the grounding member 200 also includes generally D-shaped lance features 270. In use, the D-shaped lance features 270 may help hold the grounding member 200 in place, for example, after the grounding member 200 has been installed or clipped onto the edge of a substrate. The D-shaped lance features 270 may help the grounding member 200 remain clipped onto the edge of a printed circuit board, electronic card, or other mounting surface. In some exemplary installations, the D-shaped lance features 270 may be snapped into or engagingly received within drilled or punched holes of a part or other mounting surface to create a very strong grip with excellent electrical conductivity. Still further embodiments may include other means besides the D-shaped lance features 270 to facilitate holding the grounding member in place after it has been installed. For example, other embodiments may include T-shaped lances, ribs, protrusions, etc.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, variations that do not depart from the gist of the disclosure are intended to be within the scope of the disclosure. Such variations are not to be regarded as a departure from the spirit and scope of the disclosure.

1. A grounding member configured to be clipped onto an edge portion of a substrate for establishing electrical grounding contact from at least one electrically-conductive portion on the substrate to a card guide, the grounding member comprising:
a channel configured to engagingly receive an edge portion of a substrate therein for helping mechanically retain the grounding member to the substrate and establish electrical contact with at least one electrically-conductive portion of the substrate;
a resiliently flexible contact finger element disposed generally opposite the channel, the resiliently flexible contact finger element configured so as to allow the substrate with the grounding member clipped thereon to be slidably received within a groove of a card guide, and to establish electrical contact with at least a portion of the card guide; and
a generally flat portion adjacent the resiliently flexible contact finger element, and configured to enable the grounding member to be picked up by a head associated with pick-and-place equipment.

2. A carrier tape having at least one pocket with an opening into the pocket and in which is positioned the grounding member of claim 1 such that the generally flat portion is adjacent the opening into the pocket and thereby accessible to a head associated with pick-and-place equipment for retrieval of the grounding member from the pocket.

3. The grounding member of claim 1, wherein the resiliently flexible contact finger element includes a generally rounded transverse profile and is formed from a resiliently flexible material, thereby inhibiting snagging of the resiliently flexible contact finger element within the groove as the substrate with the grounding member clipped thereon is sliding along the groove of the card guide.

4. The grounding member of claim 1, wherein the resiliently flexible contact finger element is configured so as to flex generally towards the channel when a sufficient load is applied to a contact portion defined by the finger element as the substrate with the grounding member clipped thereon is sliding along the groove of the card guide.

5. The grounding member of claim 1, wherein the resiliently flexible contact finger element has a generally arcuate transverse profile.

6. The grounding member of claim 1, wherein the channel comprises a single channel extending continuously along a length of the grounding member.

7. The grounding member of claim 1, wherein the channel includes first and second generally opposing side wall portions connected by a third wall portion.

8. (canceled)

9. The grounding member of claim 7, wherein at least one of the first and second side wall portions is inwardly angled and resiliently biased inwardly to create a flexible tension grip between the first and second side wall portions and the substrate sufficient for inhibiting removal of the grounding member from the substrate.

10. The grounding member of claim 7, wherein the first and second side wall portions are configured to cooperatively generate a sufficient clamping force to mechanically retain the grounding member to the substrate and also create sufficient contact pressure between at least a portion of the grounding member and at least one ground trace on the substrate to establish good electrical conductivity therebetween.

11. The grounding member of claim 7, wherein the channel includes at least one camming surface portion configured to contact the substrate during installation, the contact causing the first and second sidewall portions to move generally outward and away from each other to thereby facilitate positioning of the substrate's edge portion within the channel.

12. The grounding member of claim 7, wherein the resiliently flexible contact finger element is disposed generally over a first portion of the outer surface of the third wall portion, and wherein the remaining portion of the outer surface of the third wall portion defines the generally flat portion of the grounding member.

13. The grounding member of claim 7, wherein the resiliently flexible contact finger element is disposed generally over about half of the outer surface of the third wall portion, and wherein the remaining half of the outer surface of the third wall portion defines the generally flat portion of the grounding member.

14. The grounding member of claim 1, wherein the resiliently flexible contact finger element is resiliently flexible such that the resiliently flexible contact finger element flexes generally towards the channel when contacted by another surface bearing against the resiliently flexible contact finger element with a force having a component generally perpendicular to a longitudinal axis of the grounding member.

15. The grounding member of claim 1, further comprises means for helping the grounding member remain clipped onto a mounting surface.

16. The grounding member of claim 1, further comprising at least one D-shaped lance feature configured for helping the grounding member remain clipped onto a mounting surface when the D-shaped lance feature is engagingly received within an opening defined by the mounting surface.

17. A method relating to the installation of a grounding member onto an edge portion of a substrate having at least one electrically-conductive portion thereon, the grounding member having a channel, a resiliently flexible contact finger element, and a generally flat portion adjacent the resiliently flexible contact finger element, the method comprising:
applying suction to the generally flat portion of the grounding member by using a head associated with pick-and-place equipment; and
while applying the suction, moving the head to pick-up and place the grounding member onto the edge portion of the substrate such that the substrate's edge portion is received within the channel and such that at least a portion of the grounding member electrically contacts an electrically-conductive portion on the substrate.

18. The method of claim 17, further comprising sliding the substrate, having the grounding member clipped thereto, along at least one groove of a card guide such that the resiliently flexible contact finger element of the grounding member electrically contacts at least a portion of the card guide, thereby establishing electrical grounding contact from the electrically-conductive portion of the substrate to the card guide.

19. The method of claim 17, wherein the resiliently flexible contact finger element flexes generally towards the channel as the substrate slides along the at least one groove of the card guide.

20. The method of claim 17, further comprising supplying a carrier tape having at least one pocket with an opening into the pocket and in which is positioned the grounding member such that the generally flat portion is adjacent the opening into the pocket, and wherein the head retrieves the grounding member from at least one pocket of a carrier tape.

21. (canceled)

22. The method of claim 17, further comprising engagingly receiving at least one protruding portion of the grounding member within at least one opening defined by the substrate to thereby help the grounding member remain clipped onto the substrate.

23. The method of claim 17, further comprising engagingly receiving at least one lance of the grounding member within at least one opening defined by the substrate to thereby help the grounding member remain clipped onto the substrate.

24. (canceled)

25. A clip-on grounding member for establishing electrical grounding contact from at least one electrically-conductive portion on a substrate to a card guide, the clip-on grounding member comprising:
first, second, and third wall portions cooperatively defining a channel for engagingly receive an edge portion of a substrate therein, the first and second side wall portions configured to cooperatively generate a sufficient clamping force therebetween for helping mechanically retain the clip-on grounding member to the substrate and also establish electrical contact between at least one of the first, second, and third sidewall portions and at least one electrically-conductive portion on the substrate;
a resiliently flexible contact finger element disposed generally opposite the channel and generally over a first portion of the outer surface of the third wall portion, the resiliently flexible contact finger element configured so as to allow the substrate with the clip-on grounding member clipped thereon to be slidably received within a groove of a card guide, and to establish electrical contact with at least a portion of the card guide is slidably positioned within the card guide; and
a generally flat pick-up area defined by a second portion of the outer surface of the third wall portion, and configured to enable the clip-on grounding member to be picked up by a head associated with pick-and-place equipment.

26. A carrier tape having at least one pocket with an opening into the pocket and in which is positioned the clip-on grounding member of claim 25.

27. A printed circuit board including the grounding member of claim 1, at least one electrically-conductive portion, and an edge portion engagingly received within the channel of the grounding member, thereby helping mechanically retain the grounding member to the printed circuit board and establish electrical contact between the grounding member and the at least one electrically-conductive portion of the printed circuit board.

28. A printed circuit board including the clip-on grounding member of claim 26, at least one electrically-conductive portion, and an edge portion engagingly received within the channel of the grounding member, thereby helping mechanically retain the clip-on grounding member to the printed circuit board and also establish electrical contact between at least one of the first, second, and third sidewall portions and the at least one electrically-conductive portion of the printed circuit board.
